(19) United States
(12) Patent Application Publication
(10) Pub. No.: US 2026/0219395 A1
(43) Pub. Date: Jul. 30, 2026

(54) GEOMETRIC REPRESENTATION AND TEMPORAL MODELING FOR GNSS LOCALIZATION

(71) Applicant: QUALCOMM Incorporated, San Diego, CA (US)

(72) Inventors: Davide BELLI, Diemen (NL); Bence MAJOR, Amsterdam (NL); Amir JALALIRAD, Amsterdam (NL); William MORRISON, San Francisco, CA (US)

(21) Appl. No.: 19/040,909

(22) Filed: Jan. 30, 2025

(51) Int. Cl. G01S 19/01

(52) U.S. Cl. CPC G01S 19/01

(57) ABSTRACT

A determination of a position of a user equipment, includes: obtaining measurements of signals transmitted by a plurality of satellites; determining one or more residuals based on the measurements for the plurality of satellites; determining one or more corrected residuals based on one or more relationships between the measurements for the plurality of satellites in the current position fix, or between the measurements for the plurality of satellites in the current position fix and measurements for the plurality of satellites in one or more previous position fixes for the plurality of satellites; and determining the position of the user equipment based on the one or more corrected residuals and the measurements for the plurality of satellites.

### BACKGROUND

Global Navigation Satellite System (GNSS) are used to determine a global position and/or location of any number of devices that include GNSS receivers. Such GNSS receivers may be integrated into a user equipment, such as a smartphone or a smartwatch, as well as into navigation systems in different types of vehicles, including cars, trucks, ships, and aircraft. A GNSS may include a constellation of orbiting satellites that each transmit a time-synchronized signal. A user equipment may receive the time-synchronized signal from a number of GNSS satellites. By determining a time of transmission associated with each received time-synchronized signal and having knowledge of the location of each of the satellites that transmitted each received time-synchronized signal, the user equipment may determine its global location. The performance of this satellite localization may be reduced when the time-synchronized signals are obstructed by natural and man-made barriers, such as mountains, canyons, urban canyons, and tunnels.

### SUMMARY

An example user equipment, includes: one or more memories; and one or more processors communicatively coupled to the one or more memories, the one or more processors being configured to: obtain measurements of signals transmitted by a plurality of satellites; determine one or more residuals for the plurality of satellites; determine one or more corrected residuals based on one or more relationships between the measurements for the plurality of satellites in the current position fix, or between the measurements for the plurality of satellites in the current position fix and measurements for the plurality of satellites in one or more previous position fixes for the plurality of satellites; and determine the position of the user equipment based on the one or more corrected residuals and the measurements for the plurality of satellites.

An example method for determining a position of a user equipment, includes: obtaining measurements of signals transmitted by a plurality of satellites; determining one or more residuals based on the measurements for the plurality of satellites; determining one or more corrected residuals based on one or more relationships between the measurements for the plurality of satellites in the current position fix, or between the measurements for the plurality of satellites in the current position fix and measurements for the plurality of satellites in one or more previous position fixes for the plurality of satellites; and determining the position of the user equipment based on the one or more corrected residuals and the measurements for the plurality of satellites.

An example computing device, includes: means for obtaining measurements of signals transmitted by a plurality of satellites; means for determining one or more residuals based on the measurements for the plurality of satellites; means for determining one or more corrected residuals based on one or more relationships between the measurements for the plurality of satellites in the current position fix, or between the measurements for the plurality of satellites in the current position fix and measurements for the plurality of satellites in one or more previous position fixes for the plurality of satellites; and means for determining a position of a user equipment based on the one or more corrected residuals and the measurements for the plurality of satellites.

An example non-transitory, processor-readable storage medium includes processor-readable instructions for determining a position of a user equipment, the processor-readable instructions to cause one or more processors to: obtain measurements of signals transmitted by a plurality of satellites; determine one or more residuals based on the measurements for the plurality of satellites; determine one or more corrected residuals based on one or more relationships between the measurements for the plurality of satellites in the current position fix, or between the measurements for the plurality of satellites in the current position fix and measurements for the plurality of satellites in one or more previous position fixes for the plurality of satellites; and determine the position of the user equipment based on the one or more corrected residuals and the measurements for the plurality of satellites.

### BRIEF DESCRIPTION OF THE DRAWINGS

FIG. 1 illustrates a simplified diagram of an example positioning system including a user equipment and GNSS satellites.

FIG. 2 illustrates a block diagram of a user equipment.

FIG. 3 illustrates an example diagram of a GNSS system used to determine a position of the user equipment.

FIG. 4 illustrates an example diagram of the GNSS system used to determine residuals.

FIG. 5 illustrates an example positioning engine according to a first embodiment.

FIG. 6 illustrates a hemisphere plot for a first example according to the first embodiment.

FIGS. 7A-7C and FIGS. 8A-8C illustrate hemisphere plots for a second example according to the first embodiment.

FIG. 9A illustrate a diagram of an example positioning engine according to a second embodiment.

FIG. 9B illustrates an example processing of measurements by a temporal encoder according to the second embodiment.

FIGS. 10A and 10B illustrate sample residual error predictions and a graph showing performance improvements regarding residual error prediction, respectively, using one or more techniques described herein.

FIGS. 11A and 11B illustrate sample horizontal errors and a graph showing performance improvements regarding horizontal errors, respectively, using one or more techniques described herein.

FIG. 12 is a flow diagram of an example method of determining a position of a user equipment.

FIG. 13 is a flow diagram of a first embodiment of the example method for determining a position of a user equipment.

FIG. 14 is a flow diagram of a second embodiment of the example method for determining a position of a user equipment.

FIG. 15 is a flow diagram of a combination of the first and second embodiments of the example method for determining a position of a user equipment.

### DETAILED DESCRIPTION

Obtaining the locations of mobile devices may be useful for many applications including, for example, personal navigation, etc. Existing positioning methods include methods based on measuring signals transmitted from satellites. Techniques are discussed herein for determining a position of a mobile device based on residuals corrected based on one or more relationships between measurements of signals transmitted by the satellites. In a first embodiment, the one or more relationships may be between measurements for a plurality of satellites. The one or more relationships may be based on geometric features that capture relationships between measurements for the satellites in the same position fix. In a second embodiment, the one or more relationships may be between measurements for the plurality of satellites and previous measurements for the plurality of satellites. The one or more relationships may be based on temporal features that capture relationships between measurements for the same satellites in the current position fix and measurements in one or more previous position fixes. The one or more relationships may be used by a positioning engine to correct or de-weight measurements in order to enhance the accuracy of residual error predication, which may result in improved positioning performance.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

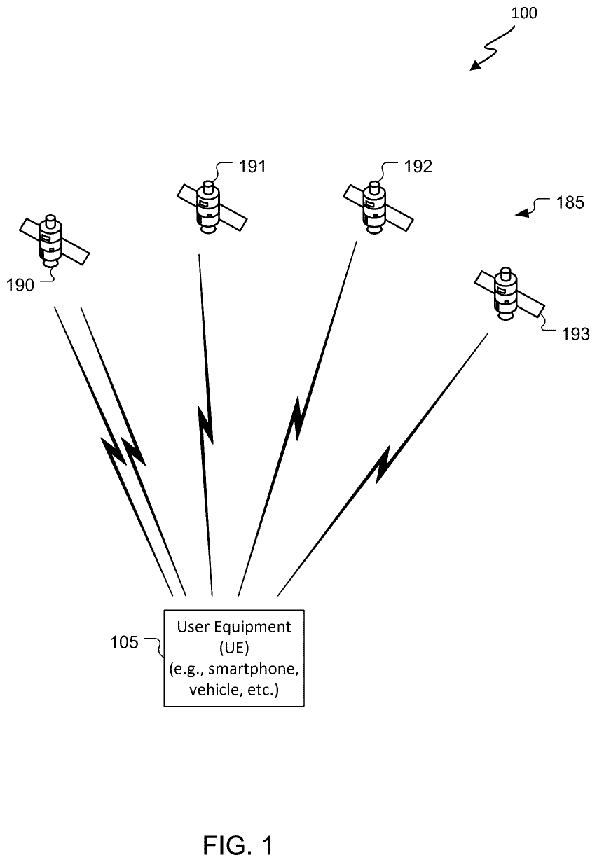

FIG. 1 illustrates a simplified diagram of an example communication system 100 including a user equipment and GNSS satellites. The user equipment (UE) 105 receives and may utilize information from a constellation 185 of satellites 190, 191, 192, 193 for a GNSS (e.g., the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS)). The communication system 100 may include additional or alternative components. With a UE-based position method, the UE 105 may obtain location measurements from signals received from the satellites 190-193 (e.g., measurements may also or instead include measurements of GNSS pseudorange, code phase, and/or carrier phase for the 190-193) and may compute a location of the UE 105.

As used herein, the term “user equipment” (UE) may be any wireless communication device (e.g., a mobile phone, laptop computer, consumer asset tracking device, etc.) capable of receiving satellite signals. UEs may be embodied by any of a number of types of devices including but not limited to printed circuit (PC) cards, compact flash devices, external or internal modems, wireless or wireline phones, smartphones, tablets, consumer asset tracking devices, asset tags, and so on. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. The UE 105 may be a vehicle-to-everything (V2X) device, such as an On Board Unit (OBU) including a GNSS receiver. Other UEs may include wearable devices (e.g., smart watches, smart jewelry, smart glasses, or headsets, etc.). Still other UEs may be used, whether currently existing or developed in the future.

An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). The location of the UE 105 may be referred to as a location of the GNSS receiver incorporated in the UE 105. Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

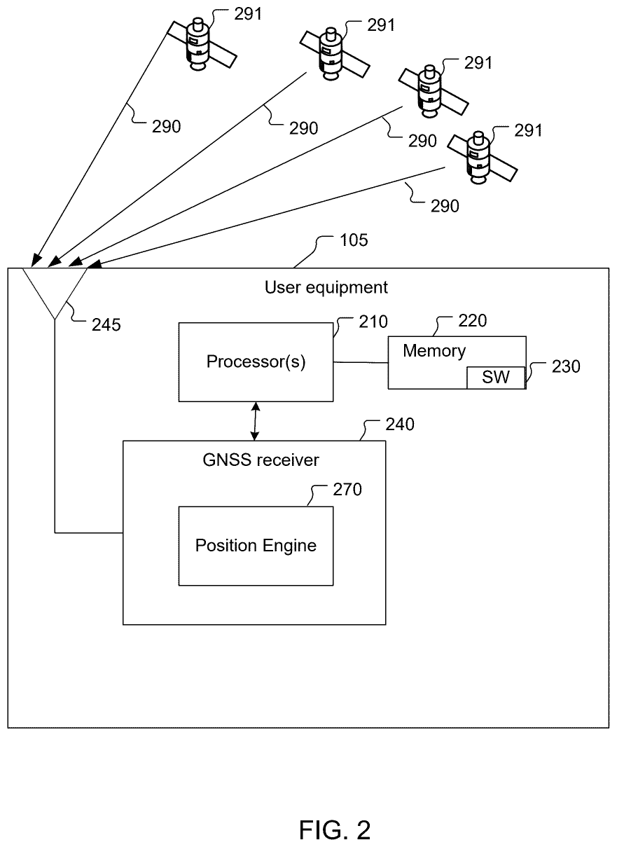

FIG. 2 illustrates an example UE 105. The UE 105 may comprise a computing platform including one or more processors 210, one or more memories 220 including software (SW) 230, and a GNSS receiver 240. The one or more processors 210 may comprise multiple processors including a general-purpose/application processor. The one or more memories 220 may be a non-transitory storage medium that may include random access memory (RAM), flash memory, disc memory, and/or read-only memory (ROM), etc. The one or more memories 220 may store the software 230 which may be processor-readable, processor-executable software code containing instructions that may be configured to, when executed, cause the processor 210 to perform various functions described herein. Alternatively, the software 230 may not be directly executable by the one or more processors 210 but may be configured to cause the one or more processors 210, e.g., when compiled and executed, to perform the functions. The description herein may refer to the one or more processors 210 performing a function, but this includes other implementations such as where the one or more processors 210 executes software and/or firmware. The description herein may refer to the processor(s) 210 performing a function as shorthand for one or more of the processors performing the function. The description herein may refer to the UE 105 performing a function as shorthand for one or more appropriate components of the UE 105 performing the function. The processor(s) 210 may include one or more memories with stored instructions in addition to and/or instead of the one or more memories 220. Functionality of the one or more processors 210 is discussed more fully below.

The GNSS receiver 240 may be capable of receiving signals 290 from acquired satellites 291 via an antenna 245. The antenna 245 is configured to transduce the signals 290 from wireless signals to wired signals, e.g., electrical or optical signals. The one or more processors 210, the one or more memories 220, and/or one or more specialized processors (not shown) may be utilized to process signals 290, in whole or in part, and/or to calculate an estimated position of the UE 105, in conjunction with the GNSS receiver 240. For example, the GNSS receiver 240 may be configured to determine a position of the UE 105 by trilateration using the signals 290. The memory 220 may store indications (e.g., measurements) of the signals 290 and/or other signals for use in performing positioning operations. The processor(s) 210, and/or one or more specialized processors, and/or the memory 220 may provide or support a Positioning Engine (PE) 270 of the GNSS receiver 240. The PE 270 may be implemented using software, hardware, or a combination of software and hardware. The GNSS receiver 240 may receive a request from an application (e.g., a map or navigation application) for a position on the UE 105 and initiates a search for satellites. Upon acquiring satellites 291 and receiving signals 290 from the satellites 291, the GNSS receiver 240 measures the signals 290 and generates measurement reports containing the measurements of the signals 290 to the PE 270. The PE 270 determines the position of the UE 105 using the measurements in the measurement reports. The GNSS receiver 240 sends the position of the UE 105 to the application. The measurement of the signals 290 and the determination of the position continues iteratively. The configuration of the UE 105 shown in FIG. 2 is an example and not limiting of the disclosure, including the claims, and other configurations may be used.

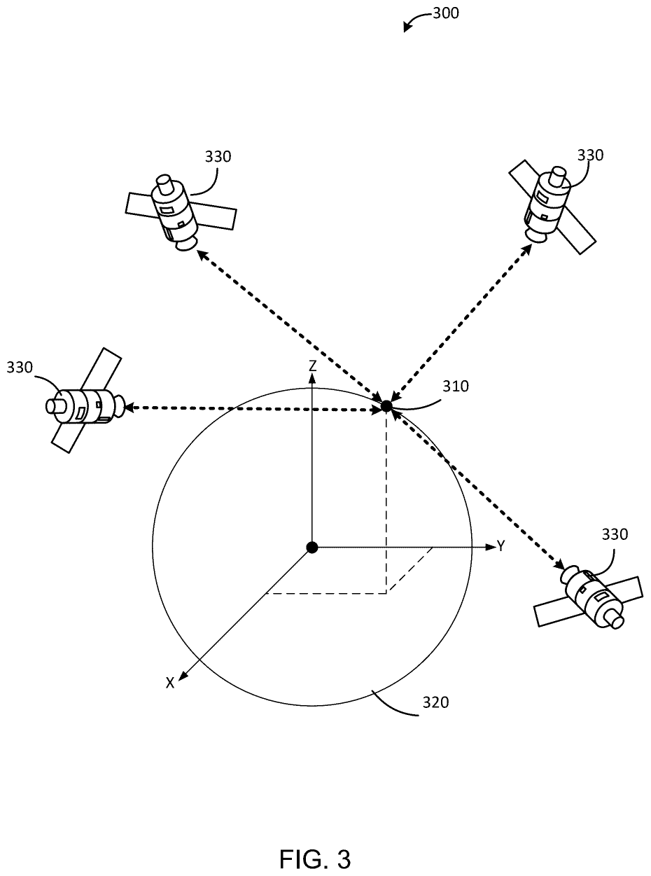

FIG. 3 is a simplified diagram of an example GNSS system illustrating how GNSS determines a location of a GNSS receiver 310 on earth 320. The GNSS receiver 310 (e.g., GNSS receiver 240) may be incorporated into a UE (e.g., UE 105), and GNSS positioning may be one of a plurality of positioning techniques that may be employed to determine the location of the UE 105. The GNSS system 300 may enable an accurate position fix of the GNSS receiver 310, which receives signals from satellites 330 (e.g., satellites 190-193) from one or more GNSS constellations.

GNSS positioning is based on trilateration, which is a method of determining position by measuring distances to points at known coordinates. In general, the determination of the position of a GNSS receiver 310 in three dimensions may rely on a determination of the distance between the GNSS receiver 310 and four or more acquired satellites 330. As illustrated, 3D coordinates may be based on a coordinate system (e.g., XYZ coordinates; latitude, longitude, and altitude; etc.) centered at the earth's center of mass. A distance between each satellite 330 and the GNSS receiver 310 may be determined using precise measurements made by the GNSS receiver 310 of a difference in time from when a signal is transmitted from the respective satellite 330 and when it is received at the GNSS receiver 310. To help ensure accuracy, the GNSS receiver 310 may make a determination of when the respective signal from each satellite 330 is received, along with additional factors considered and accounted for. These factors include, for example, clock differences at the GNSS receiver 310 and satellite 330 (e.g., clock bias), a precise location of each satellite 330 at the time of transmission (e.g., as determined by the broadcast ephemeris), the impact of atmospheric distortion (e.g., ionospheric and tropospheric delays), and the like. Trilateration may also estimate the clock difference between the UE 105 and the acquired satellites. A clock error may be different for each satellite system (GLONASS, GPS, Galileo, etc.). In summary, trilateration estimates three numbers representing 3D coordinates, and then one number for each satellite system, which represents the time difference between local time and the satellite system's time.

GNSS measurements of signals transmitted by the satellites 330 may be taken and errors of the measurements may be determined based on the signals. GNSS positioning may be improved by using residuals and weights. Residuals and weights may be derived for weighted least squares (WLS) based trilateration, given measurement errors. In some examples, a machine learning (ML) model may be trained using ground truth measurement errors. This trained model may be used to estimate errors at inference time. In some examples, measured distances and expected distances are used to calculate the residuals, as described below.

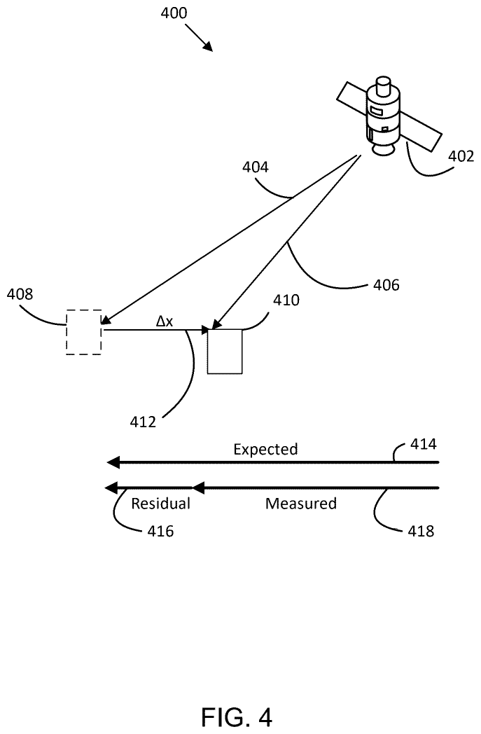

FIG. 4 is a diagram of a system 400 illustrating use of satellite signals (that travel distances 404, 406) to find a position 410 of a UE (e.g., position of GNSS receiver 240 of the UE 105) by determining correction Δx 412. As illustrated, a satellite 402 may transmit a signal that has a measured distance 406 (e.g., as measured by the GNSS receiver 240) that indicates an actual location 410 of the UE 105. This measured distance 406 may not be accurate as compared to an expected distance 404 that indicates an estimated location 408 of the UE 105 (e.g., an initial position estimate, which may be determined without using GNSS measurements). A difference Δx 412 (e.g., correction to the estimated location 408) represents a difference between the estimated location 408 and the actual location of the UE 105.

Arrows 414, 416, 418 illustrate how a residual is determined from a difference in expected distance 404 and measured distance 406. An expected distance arrow 414 (corresponding to expected distance 404) indicates the expected distance that would be measured at the estimated location 408, measured distance arrow 418 indicates the distance that was actually measured by the GNSS receiver 240 of the UE 105 (e.g., at the actual location 410), and a residual arrow 416 indicates a difference between the expected distance arrow 414 and the measured distance arrow 418.

For example, measured distances to the satellites may be input to a Weighted Least Squares (WLS) algorithm to determine the correction Δx as follows:

$$Δ x = {( {H}^{T} W H )}^{- 1} {H}^{T} W r \qquad ( Eq . 1 )$$

where r is the residual representing a difference between measured distances and expected distances at the estimated location,
W is the weight representing the importance of each measurement, and
H represents information about a satellite's position in the sky.
   Once the correction Δx is determined, the correction Δx may be applied to the estimated location to obtain an improved location (e.g., closer to actual location 410). The WLS algorithm may find Δx by running iteratively until the correction value converge.

In outdoor positioning using measurements of signals from GNSS satellites, the outdoor positioning tasks start with a “first fix scenario”, where an initial position of the UE 105 is determined without any prior knowledge about measurements and the UE's location. The positioning then continues with the “tracking scenario”, where information about a previous position fix, or time step, is available to determine the current UE location. Kalman filters may be used by the GNSS receiver 240 to track the UE position over time using the measurements. Kalman filters update the estimated positions of the UE by incorporating new measurements over time, progressively refining the estimated positions and reducing the impact of noise with each new set of measurements, effectively “filtering out” the noise as more measurements are received. The accuracy in both the first fix and tracking scenarios may be hindered by noise in the measurements. Referring to FIG. 2, in certain terrain, such as dense urban areas, the signals 290 from the satellites 291 may reflect off buildings and other obstacles before reaching the GNSS receiver 240 due to a lack of a line of sight (LOS) between the satellites 291 and the GNSS receiver 240. The signals 290 takes a longer path to reach the GNSS receiver 240, and the additional delay may result in errors in the position estimate. The accuracy may also be hindered by noise due to a multipath problem, where the same signals 290 from the satellites 291 may reach the GNSS receiver 240 through multiple paths (due to reflections or direct path plus reflections). Multipath signals may cause a faulty measurement of the GNSS receiver's distance to the satellites 291. Such noise may result in horizontal positioning errors that may be up to many times larger than under an open sky, leading to service quality degradation for location-based services on the UE 105.

ML models may be used to correct residuals based on features from the GNSS measurements, and the corrected residuals may be input into the Kalman filters to improve the performance of the position fix. Common features may include: signal strength and frequency; satellite elevation and azimuth; and code and carrier phase measurements and rates. However, Kalman filters are unable to detect inconsistencies or redundant measurements with respect to other measurements. Kalman filters are also unable to detect measurements which are unstable over time for the same SVs, e.g., due to multipath or NLOS problems. Further, the commonly used features describe the individual measurement but do not describe the relationships between the measurements in the same position fix.

Techniques discussed herein capture one or more relationships between measurements for a plurality of satellites. In one embodiment, one or more geometric relationships between the measurements for the plurality of satellites are captured, and redundancy, instability, and/or outlier between the measurements are identified. In another embodiment, one or more temporal relationships between the measurements for the plurality of satellites and previous measurements for the plurality of satellites are captured, and measurements that are unstable over time are identified. The one or more relationships may be used to improve the prediction of errors in the measurements, which may allow for the calculation of more accurate residuals. Use of more accurate residuals may result in more accurate position estimates for the UE.

In the first embodiment, position fix performance may be improved by including one or more geometric relationships between the GNSS measurements in the current or same position fix and to provide the one or more relationships as inputs to a residuals correction module. The one or more relationships may include, for each satellite, relationships between the satellite and the other satellites based on the locations of the satellites in the sky. The residuals correction module for example, may be implemented at least in part by a ML model that may be trained to determine corrections to the residuals based at least on the one or more geometric relationships. For example, the one or more geometric relationships may describe the redundancy across the measurements, instability, outlier-ness, and geometric quality of a position fix, as described further below.

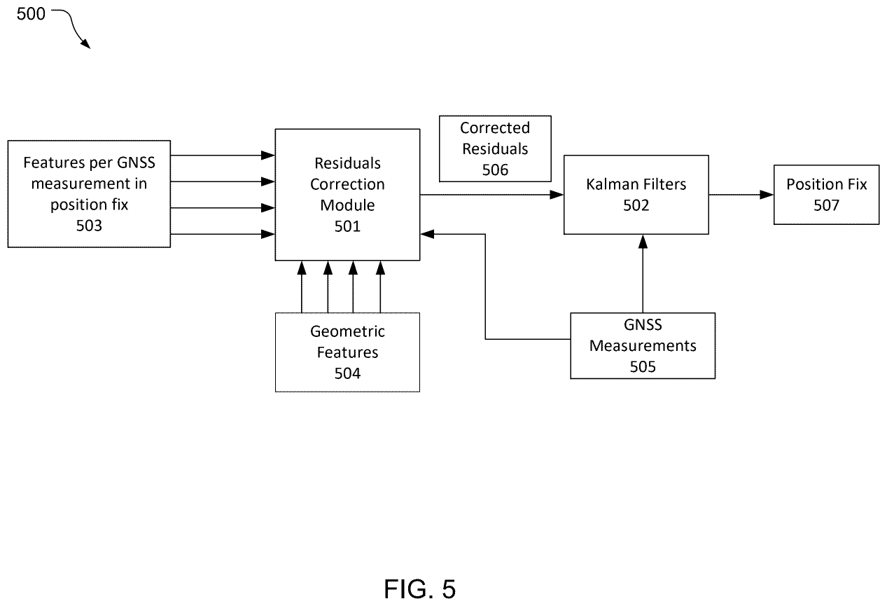

FIG. 5 illustrates an example PE according to the first embodiment. The PE 500 (e.g., PE 270) includes the residuals correction module 501 configured to receive one or more features 503 per GNSS measurement in a position fix and one or more geometric features 504. The one or more features 503 may include non-geometric features, e.g., signal strength, signal frequency, and satellite elevation and azimuth. The one or more geometric features 504 may include, e.g., dilution of precision (DOP) contribution, geometric redundancy, gradient of least square (LS) solution, and a LS contribution, as described further below. The DOP contribution, the geometric redundancy, the gradient of LS solution, and the LS contribution may be used independently or in any combination. For example, the residuals correction module 501 may include a ML model trained to determine one or more geometric relationships between the measurements for the satellites based on the one or more geometric features 504 and to predict corrections for the residuals for the position fix based on the one or more geometric relationships. The residuals correction module 501 may output corrected residuals 506 to the Kalman filters 502. The Kalman filters 502 may determine the position fix 507 for the UE 105 based on the GNSS measurements 505 and the corrected residuals 506. For example, each of the geometric features 504 capture one or more geometric relationships between satellites in a position fix. The one or more geometric relationships may be used by the residuals correction module 501 for satellite selection, channel selection, measurement weighing, and/or uncertainty estimation.

In an example implementation, the one or more geometric features 504 may include a dilution of precision (DOP) contribution to capture geometric redundancy between measurements. A DOP measures how much a GNSS position may be degraded by the geometry of the satellites, i.e., angles between the satellites, used by the GNSS receiver 240. The computed DOP may include one or more of a position dilution of precision (PDOP), a time dilution of precision (TDOP), a geometric dilution of precision (GDOP), and/or a horizontal dilution of precision (HDOP). The DOP contribution may be calculated by determining a difference between (1) a DOP for a current position fix that includes measurements for a given satellite, and (2) a DOP for the current position fix without the measurements for the given satellite, i.e., with the measurements for the given satellite removed. The DOP contribution may be expressed as:

$${d ( DOP )}_{i} = DOP ( m e a {s}_{\{ 0 … N \}} ) - D O P ( m e a {s}_{\{ 0 … N \} - \{ i \}} ) \qquad ( Eq \text{.2} )$$

where d(DOP)ᵢ is the DOP contribution of the given satellite,
N is the number of satellites acquired in the position fix,
i is an index for a given satellite,
DOP(meas_{{0 . . . N}}) is the DOP for the measurements for the N satellites, and
   DOP(means_{{0 . . . N}-{i}}) is the DOP for the measurements for the N satellites with the measurements for the given satellite removed.

The DOP contribution, d(DOP)ᵢ, captures the amount of geometric redundancy between measurements in the same position fix. For example, the larger the DOP contribution for the given satellite i, the less redundant are the measurements for the given satellite i, and the larger the impact of removing the measurements from the position fix. The smaller the DOP contribution for the given satellite i, the more redundant the measurements for the given satellite i, and the smaller the impact of removing the measurements from the position fix. The smaller the DOP contribution for the given satellite i, the more likely the PE 270 will de-weight the measurements for the given satellite i in the residuals correction.

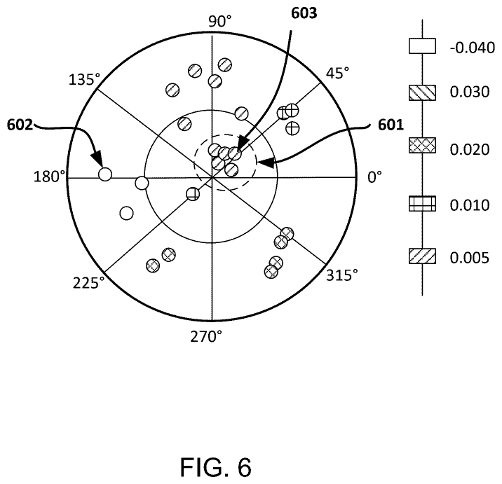

For example, the hemisphere plot of FIG. 6 illustrates the positions of satellites in the sky, with each circle representing a satellite and the pattern of each circle representing each satellite's DOP contribution. Assume that circle 603 represents satellite i, and circle 603 is among a cluster of satellites 601. The measurements for the satellites in the cluster 601 may be similar to each other due to their proximity, such that d(DOP)ᵢ may indicate that the measurements for the satellite i may be redundant with the measurements of the other satellites in the cluster 601. In another example, assume that circle 602 represents satellite i, where satellite i is not in close proximity to other satellites, such that d(DOP)ᵢ indicates that the measurements from satellite i may not be redundant.

In another example implementation, the one or more geometric features 504 may include a geometric redundancy for the given satellite i, which may include a sum of alignments of the angles between the given satellite i and the remaining satellites ({0 . . . N}−i). The sum of alignments captures an angle of the given satellite i with respect to the remaining satellites ({0 . . . N}−i). The higher the angle, the less redundant the measurements for the given satellite i. The lower the angle, the more redundant the measurements for the given satellite i. The sum of alignments may be expressed as:

$$G e o m R e {d}_{i} = {\sum }_{j ϵ \{ 0 … N \} - \{ i \}} 1 - 2 * {cos}^{2} ( {θ}_{i , j} ) \qquad ( Eq . 3 )$$

where GeomRedᵢ is the geometric redundancy for the given satellite,
i is the index for the given satellite,
j is the index for a given satellite of the remaining satellites {0 . . . N}−i,
θ is the angle between satellite i and satellite j, and
cos²(θ_{i,j}) is the alignment between satellite pairs, i.e., satellite i and satellite j.
   The alignment cos²(θ_{i,j}) may be expressed as:

$$cos ( 2 {θ}_{i , j} ) = 2 {cos}^{2} ( {θ}_{i , j} ) - 1 = 2 {( {v}_{i} \cdot {v}_{j} )}^{2} - 1 \qquad ( Eq \text{.4} )$$

where vᵢ and vⱼ are vectors from an observer to satellite i and satellite j, respectively. The greater the geometric redundancy for the given satellite i, the more likely the PE 270 will de-weight the measurements for the given satellite i in the residuals correction.

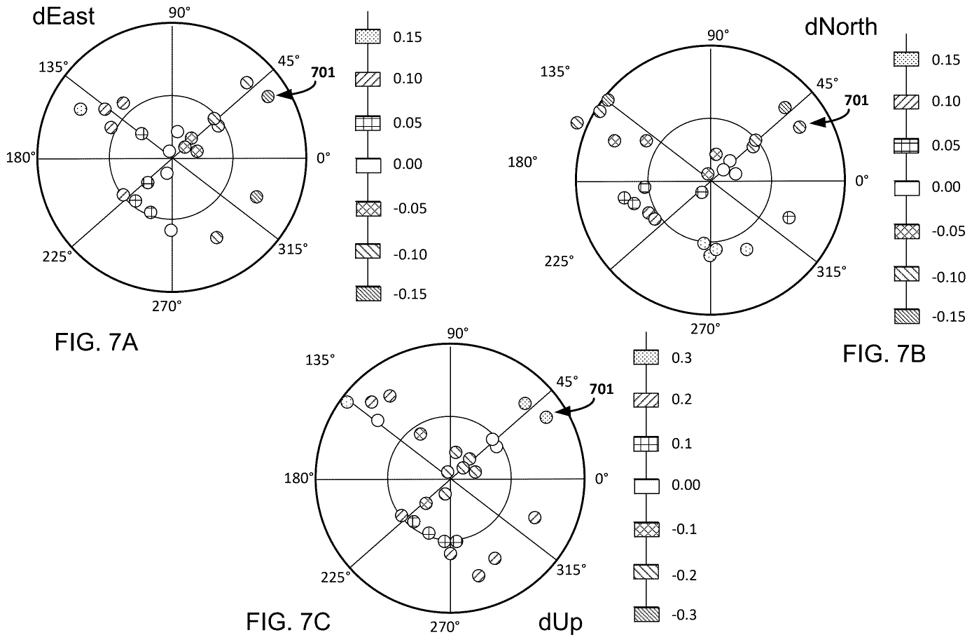

In another example implementation, the one or more geometric features 504 may include a gradient of least-squares (LS) solution to capture unstable measurements. The gradient of the LS solution captures how much the LS solution for a given satellite would change based on a change in the residual r of the measurements for the given satellite. The higher the gradient, the more unstable the residual r. The gradient of LS solution may be expressed as a derivative:

$$\frac{d ( {X}_{W L S} )}{d r} = \frac{d ( {( {H}^{t} H )}^{- 1} {H}^{t} r )}{d r} = {( {H}^{t} H )}^{- 1} {H}^{t} \qquad ( Eq . 5 )$$

where r is a residual,
X is the change in r,
WLS is weighted least square, and
H represents a matrix with trigonometric functions of a geometry of the satellites.
   For example, the hemisphere plots of FIGS. 7A-7C illustrate a first example set of satellites in the sky along the East (FIG. 7A), North (FIG. 7B), and Up (FIG. 7C) directions. Each circle represents a satellite, and the pattern of each circle represents the corresponding satellite's gradient of LS solution. Each of the gradients of LS solutions indicate the amount of change in the residual r that results from a change in the gradient X, as well as the direction of change. For example, for satellite 701, the gradient of LS solution moves West (i.e., negative in the East direction (≈−0.15)), South (i.e., negative in the North direction (≈−0.10)), and up (i.e., positive in the Up direction (≈0.3)). The hemisphere plots of FIGS. 8A-8C illustrate the gradients of LS solutions for a second example set of satellites in the sky along the East (FIG. 8A), North (FIG. 8B), and Up (FIG. 8C) directions. The satellites in FIGS. 8A-8C are sparser than the satellites in FIGS. 7A-7C. For example, for satellite 801, the gradient of LS solution moves East (i.e., positive in the East direction (≈1)), South (i.e., negative in the North direction (≈−0.2)), and neutral along the Up direction (≈0). In this example, the gradient of LS solution for satellite 801 is higher than for satellite 701 in at least the Eastern and Northern directions. This indicates that a change in the residual r for satellite 801 has a higher impact on the position fix than a change in the residual r for satellite 701 in at least the Eastern and Northern directions. The greater the gradient of LS solution, the more likely the PE 270 will de-weight the measurements for the given satellite i in the residuals correction.

In another example implementation, the one or more geometric features 504 may include a LS contribution of a measurement in order to capture outlier measurements. The LS contribution indicates how much a measurement contributes to the LS solution, including the impact from the corresponding residual. The LS contribution may be determined by removing each measurement for a satellite and computing a resulting change in the LS solution. The LS contribution may be expressed with a scaling of Eq. 4 with the sign and magnitude of the residuals:

$$\frac{d ( {X}_{W L S} )}{d r} * r = {( {H}^{t} H )}^{- 1} {H}^{t} * r \qquad ( Eq . 6 )$$

The greater the LS contribution, the more likely the PE 270 will de-weight the measurements for the given satellite i in the residuals correction.

As set forth above, each of the geometric features 504 captures one or more geometric relationships between satellites in a position fix. The geometric features 504 may be used by the residuals correction module 501 for enhance the prediction of residual errors.

In a second embodiment, position fix performance may be improved by including one or more temporal features to the inputs to the residuals correction module 501 from processing GNSS measurements across position fixes and aggregating the features of the GNSS measurements over time. In an example implementation, one or more temporal encoders may be used to process measurements across position fixes, capture temporal patterns (e.g., level of noise in the measurements or temporal consistency), and generate the one or more temporal features.

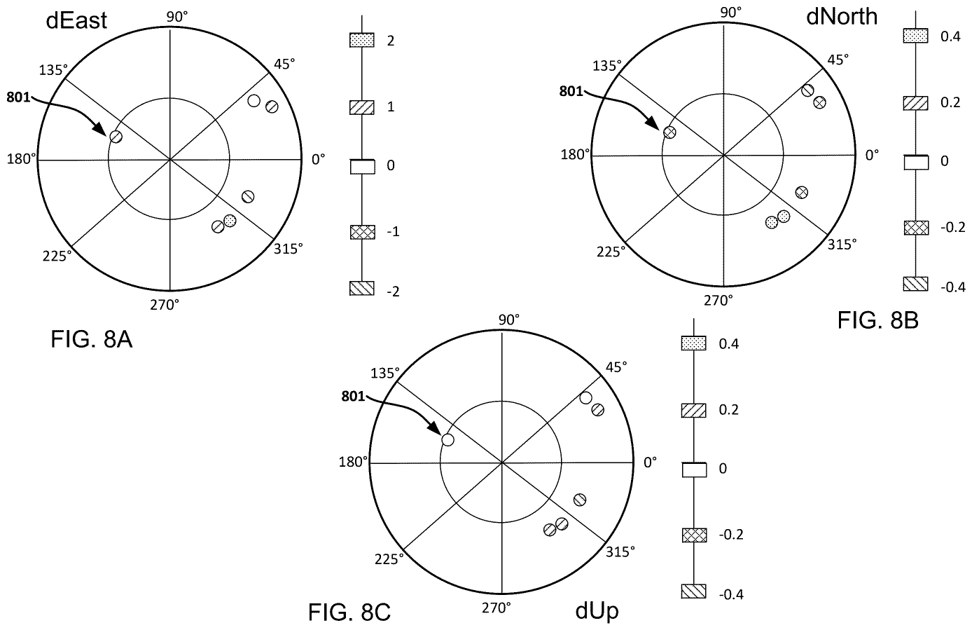

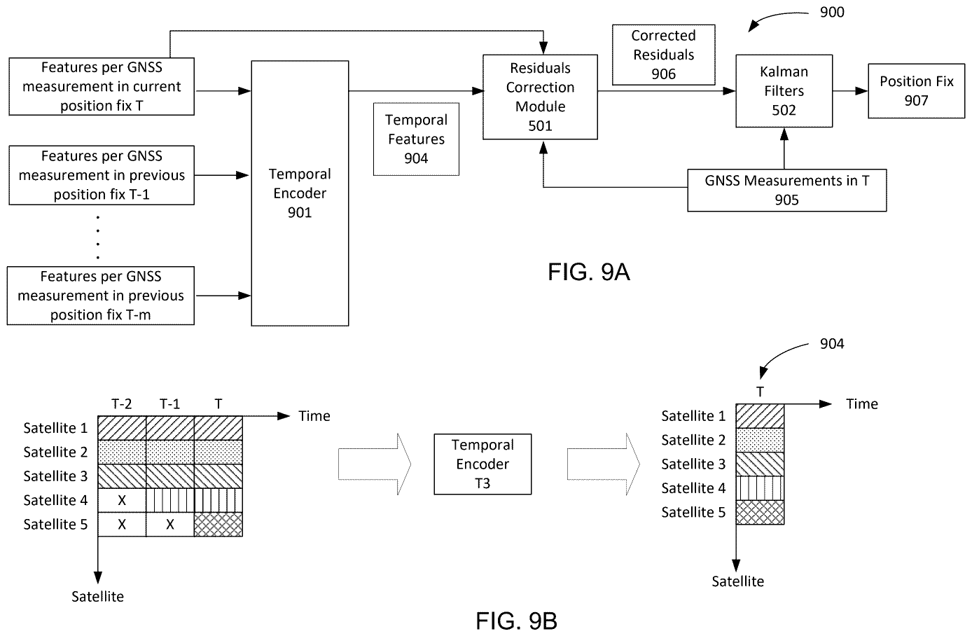

FIG. 9A illustrate a diagram of an example PE according to the second embodiment. The PE 900 (e.g., PE 270) includes the residuals correction module 501 configured to receive one or more temporal features 904 from one or more temporal encoders 901. The one or more temporal encoders 901 processes consecutive measurements from each satellite and aggregates the features over time, capturing temporal patterns in the measurements, such as level of noise in the measurements or temporal consistency. The residuals correction module 501 may use the temporal features 904 to determine one or more temporal relationships between the measurements for the satellites and previous measurements for the satellites in order to weigh the measurements from each satellite of a current position fix. For example, the one or more temporal encoders 901 may process each measurement from each satellite in the current position fix T, in combination with the measurements from the same satellites in one or more previous position fixes, T−1 . . . T−m, where T through T−m defines the temporal window. Referring to the example illustrated in FIG. 9B, a temporal window may be defined as T through T−2. The temporal encoder 901 may obtain measurements for satellites 1, 2, 3, 4, and 5 at the current position fix T. In addition, the temporal encoder 901 obtains measurements, for the same satellites, obtained in previous position fixes T−1 and T−2. In the illustrated example, satellite 4 was not included in the position fix T−2, and thus no measurements for satellite 4 are available to the temporal encoder 901 for position fix T−2. Similarly, satellite 5 was not included in the position fixes T−1 or T−2, and thus no measurements for satellite 5 are available to the temporal encoder 901 for position fixes T−1 or T−2. In one implementation, the temporal encoder 901 processes the measurements for each satellite in position fixes T, T−1, and T−2, with the time dimension, compacts the measurements to generate a feature set for each satellite, and generates a scalar of the feature sets as the temporal features 904 for use in the current position fix T. The temporal features 904 thus capture one or more relationships between measurements in a current position fix and measurements in one or more previous position fixes for each satellite acquired in the current position fix. Referring to FIG. 9A, the temporal features 904, as well as non-temporal features per GNSS measurement in the current position fix T, may be included in the inputs to the residuals correction module 501 and used to determine one or more temporal relationships between the measurements in the current position fix and the measurements in one or more previous position fixes. The one or more temporal relationships may be used by the residuals correctio module 501 for measurement weighting in the generation of the corrected residuals 906. For example, a temporal feature set for satellite 1 may indicate the level of instability of measurements for satellite 1 over T−2 through T. The greater the instability, the more likely the residuals correction module 501 will de-weigh the measurements for satellite 1 in the residuals correction. The corrected residuals 906 and the GNSS measurements 905 in current position fix T may be input into the Kalman filters 502, which outputs a position fix 907 based on the corrected residuals 906 and the GNSS measurements 905.

In one example, the temporal encoder 901 may be implemented using a k nearest neighbor (k-NN) temporal encoder that concatenates the features for the nearest satellites for a K number of previous position fixes. A MLP network may be used to process the relation across the concatenated features. In another example, the temporal encoder 901 may be implemented using a recurrent neural network (RNN)-type, such as gated recurrent unit (GRU), that performs temporal aggregation for a certain history window (e.g., T through T−m). In another example, the temporal encoder 901 may be implemented using a self-attention encoder which captures dependencies and relationships for measurements within a sequence of position fixes.

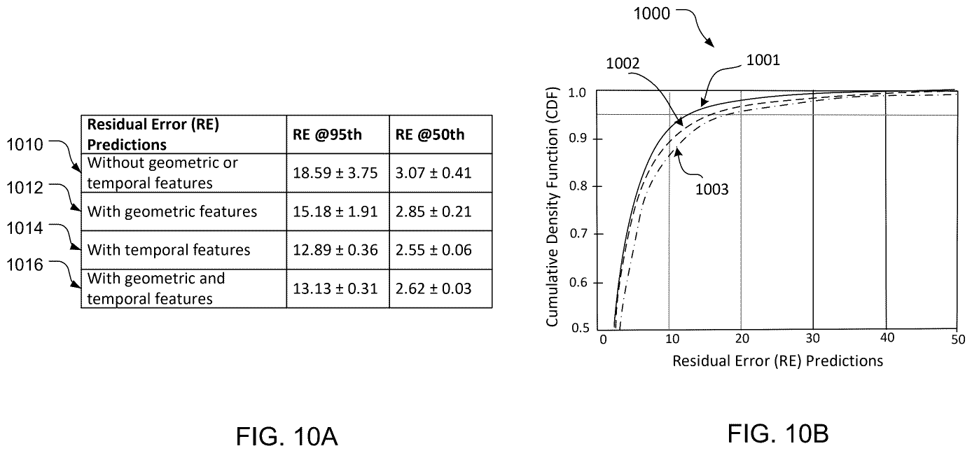

FIGS. 10A and 10B illustrate sample residual error predictions and a graph showing performance improvements regarding residual error prediction, respectively, using one or more techniques described herein. Referring to FIG. 10A, samples of residual error (RE) predications are shown for techniques without use of geometric features 504 or temporal features 904 (1010), with the use of geometric features 504 according to the first embodiment (1012), with the use of temporal features 904 according to the second embodiment (1014), and with the use of a combination of geometric features 504 and temporal features 904 according to a combination of the first and second embodiments (1016). As shown in the sample RE predictions in the 95^{th} percentile and 50^{th} percentile of the median error for each technique, reductions in RE prediction may be realized with the use of geometric features 504, temporal features 904, and the combination of geometric 504 and temporal 904 features, as compared to without the use of geometric features 504 or temporal features 904. Referring to FIG. 10B, the graph 1000 illustrates the RE versus the cumulative density function (CDF). The CDF represents the probability that a GNSS positioning error will be less than or equal to a specific value. Curve 1001 illustrates the RE predictions without use of geometric features 504 or temporal features 904, as described herein. Curve 1002 illustrates the RE predictions with the use of geometric features 504. Curve 1003 illustrates the RE predictions with the use of temporal features 904. As a comparison of curve 1001 with the curves 1002 and/or 1003 illustrate, performance improvements in terms of RE predictions may be realized with the use of geometric features 504 and/or temporal features 904.

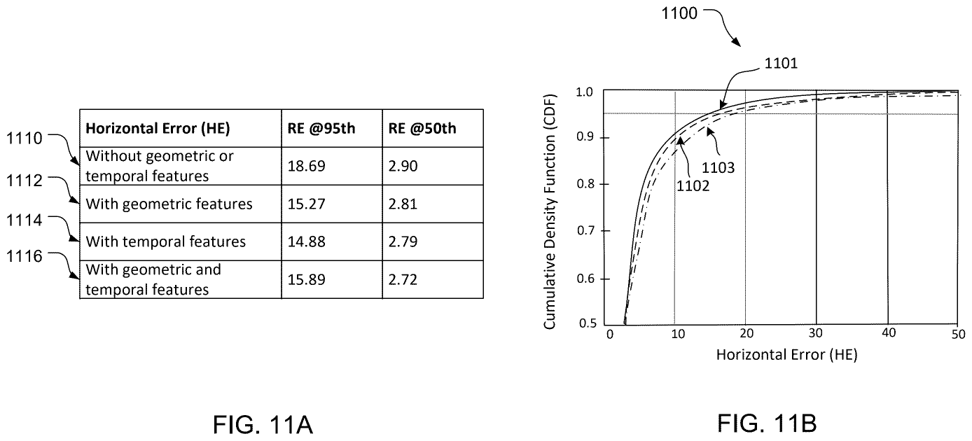

FIGS. 11A and 11B illustrate sample horizontal errors and a graph showing performance improvements regarding end-to-end localization performance in terms of horizontal errors (HE), respectively, using one or more techniques described herein. Referring to FIG. 11A, samples of HE are shown for techniques without use of geometric features 504 or temporal features 904 (1110), with the use of geometric features 504 according to the first embodiment (1112), with the use of temporal features 904 according to the second embodiment (1114), and with the use of a combination of geometric 504 and temporal 904 features according to a combination of the first and second embodiments (1116). As shown in the sample HE in the 95^{th} percentile and 50^{th} percentile of the median error for each technique, reductions in HE are realized with the use of geometric features 504, temporal features 904, and the combination of geometric 504 and temporal 904 features, as compared to without the use of geometric 504 or temporal 904 features. Referring to FIG. 11B, in graph 1100, curve 1101 illustrates the HE without use of geometric features 504 or temporal features 904, as described herein. Curve 1102 illustrates the HE with the use of geometric features 504. Curve 1103 illustrates the HE with the use of temporal features 904. As a comparison of curve 1101 with the curves 1102 and/or 1103 illustrate, performance improvements in terms of HE may be realized with the use of geometric features 504 and/or temporal features 904.

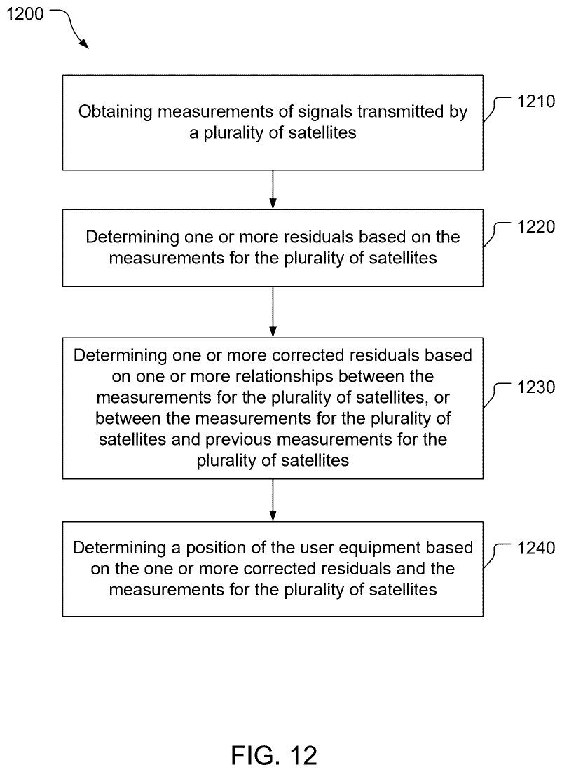

FIG. 12 is a flow diagram of an example method 1200 for determining a position of a UE 105. The implementation of the method 1200 includes the following features. At stage 1210, the method 1200 includes obtaining measurements of signals transmitted by a plurality of satellites. The one or more processors 210, possibly in combination with the one or more memories 220, in combination with the GNSS receiver 240, may comprise means for obtaining measurements of signals transmitted by a plurality of satellites.

At stage 1220, the method 1200 includes determining one or more residuals based on the measurements for the plurality of satellites. The one or more processors 210, possibly in combination with the one or more memories 220, in combination with the GNSS receiver 240, may comprise means for determining one or more residuals based on the measurements for the plurality of satellites.

At stage 1230, the method 1200 includes determining one or more corrected residuals based on one or more relationships between the measurements for the plurality of satellites, or between the measurements for the plurality of satellites and previous measurements for the plurality of satellites. For example, the one or more relationships may include one or more geometric relationships between the measurements for the plurality of satellites. For another example, the one or more relationships may include one or more temporal relationships between the measurements for the plurality of satellites and previous measurements for the plurality of satellites. For another example, the one or more relationships may include a combination of the one or more geometric relationships and the one or more temporal relationships. The one or more processors 210, possibly in combination with the one or more memories 220, in combination with the GNSS receiver 240, may comprise means for determining one or more corrected residuals based on one or more relationships between the measurements for the plurality of satellites, or between the measurements for the plurality of satellites and previous measurements for the plurality of satellites.

At stage 1240, the method 1200 includes determining a position of the UE based on the one or more corrected residuals and the measurements for the plurality of satellites. The one or more processors 210, possibly in combination with the one or more memories 220, in combination with the GNSS receiver 240, may comprise means for determining a position of the UE based on the one or more corrected residuals and the measurements for the plurality of satellites.

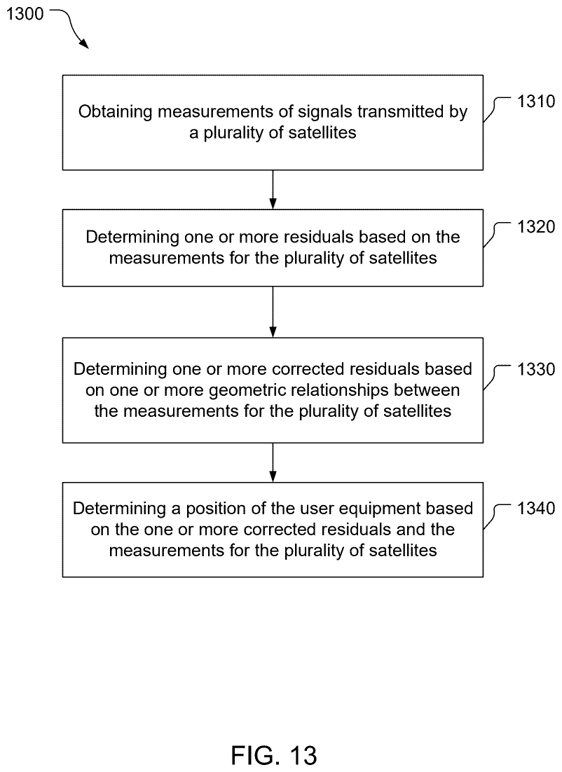

FIG. 13 is a flow diagram of a first embodiment of the example method for determining a position of a UE 105. The implementation of the method 1300 includes the following features. At stage 1310, the method 1300 includes obtaining measurements of signals transmitted by a plurality of satellites. The one or more processors 210, possibly in combination with the one or more memories 220, in combination with the GNSS receiver 240, may comprise means for obtaining measurements of signals transmitted by a plurality of satellites.

At stage 1320, the method 1300 includes determining one or more residuals based on the measurements for the plurality of satellites. The one or more processors 210, possibly in combination with the one or more memories 220, in combination with the GNSS receiver 240, may comprise means for determining one or more residuals based on the measurements for the plurality of satellites.

At stage 1330, the method 1300 includes determining one or more corrected residuals based on one or more geometric relationships between the measurements for the plurality of satellites. The one or more processors 210, possibly in combination with the one or more memories 220, in combination with the GNSS receiver 240, may comprise means for determining one or more corrected residuals based on one or more geometric relationships between the measurements for the plurality of satellites.

For example, the one or more geometric relationships between the measurements for the plurality of satellites may include one or more geometric features between the plurality of satellites.

In one example implementation, the one or more geometric features include a DOP contribution to capture the amount of geometric redundancy between measurements in the same position fix. The smaller the DOP contribution for a given satellite, the more redundant the measurements for the given satellite, and the smaller the impact of removing the measurements from the position fix.

In another example implementation, the one or more geometric features include a geometric redundancy for a given satellite, which may include a sum of alignments of the angles between the given satellite and the remaining satellites acquired in the current position fix. The sum of alignments captures an angle of the given satellite with respect to the remaining satellites. The higher the angle, the less redundant the measurements for the given satellite. The lower the angle, the more redundant the measurements for the given satellite.

In another example implementation, the one or more geometric features include a gradient of LS solution to capture unstable measurements. The gradient of the LS solution captures an amount a LS solution for a given satellite changes based on a change in the residual of the measurements for the given satellite. The higher the gradient, the more unstable the residual.

In another example implementation, the one or more geometric features include a LS contribution. The LS contribution indicates how much a measurement for a given satellite contributes to the LS solution, including the impact from the corresponding residual. The LS contribution may be determined by removing each measurement for the given satellite and computing a resulting change in the LS solution for the given satellite. The greater the LS contribution, the more likely the PE 270 will de-weigh the measurements for the given satellite in the residuals correction.

At stage 1340, the method 1300 includes determining a position of the UE based on the one or more corrected residuals and the measurements for the plurality of satellites. The one or more processors 210, possibly in combination with the one or more memories 220, in combination with the GNSS receiver 240, may comprise means for determining a position of the UE based on the one or more corrected residuals and the measurements for the plurality of satellites.

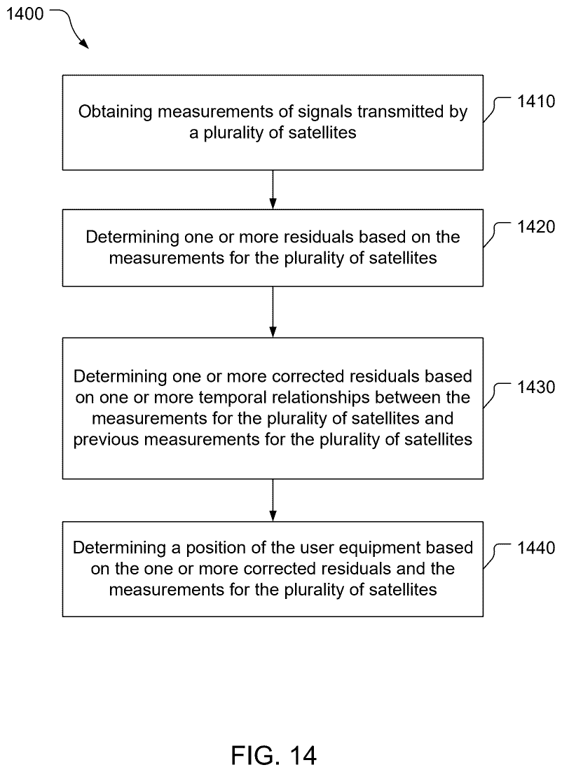

FIG. 14 is a flow diagram of a second embodiment of the example method 1400 for determining a position of a UE 105. The implementation of the method 1400 includes the following features. At stage 1410, the method 1400 includes obtaining measurements of signals transmitted by a plurality of satellites. The one or more processors 210, possibly in combination with the one or more memories 220, in combination with the GNSS receiver 240, may comprise means for obtaining measurements of signals transmitted by a plurality of satellites.

At stage 1420, the method 1400 includes determining one or more residuals based on the measurements for the plurality of satellites. The one or more processors 210, possibly in combination with the one or more memories 220, in combination with the GNSS receiver 240, may comprise means for determining one or more residuals based on the measurements for the plurality of satellites.

At stage 1430, the method 1400 includes determining one or more corrected residuals based on one or more temporal relationships between the measurements for the plurality of satellites and previous measurements for the plurality of satellites. The one or more processors 210, possibly in combination with the one or more memories 220, in combination with the GNSS receiver 240, may comprise means for determining one or more corrected residuals based on one or more temporal relationships between the measurements for the plurality of satellites and previous measurements for the plurality of satellites.

For example, the one or more temporal relationships between the measurements for the plurality of satellites and previous measurements for the plurality of satellites may include one or more temporal features determined from GNSS measurements across position fixes and aggregating the features of the GNSS measurements over time. In an example implementation, one or more temporal encoders may process consecutive measurements from each satellite and aggregate the features over time, capturing temporal patterns in the measurements, such as level of noise in the measurements or temporal consistency. The temporal features may be used for measurement weighting in the generation of the corrected residuals.

At stage 1440, the method 1400 includes determining a position of the UE based on the one or more corrected residuals and the measurements for the plurality of satellites. The one or more processors 210, possibly in combination with the one or more memories 220, in combination with the GNSS receiver 240, may comprise means for determining a position of the UE based on the one or more corrected residuals and the measurements for the plurality of satellites.

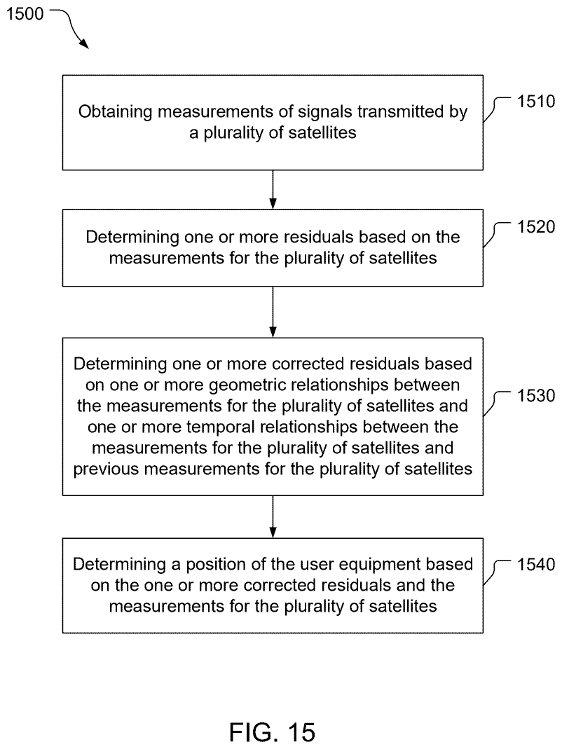

FIG. 15 is a flow diagram of a combination of the first and second embodiments of the example method 1500 for determining a position of a UE 105. At stage 1510, the method 1500 includes obtaining measurements of signals transmitted by a plurality of satellites. The one or more processors 210, possibly in combination with the one or more memories 220, in combination with the GNSS receiver 240, may comprise means for obtaining measurements of signals transmitted by a plurality of satellites.

At stage 1520, the method 1500 includes determining one or more residuals based on the measurements for the plurality of satellites. The one or more processors 210, possibly in combination with the one or more memories 220, in combination with the GNSS receiver 240, may comprise means for determining one or more residuals based on the measurements for the plurality of satellites.

At stage 1530, the method 1500 includes determining one or more corrected residuals based on one or more geometric relationships between the measurements for the plurality of satellites and one or more temporal relationships between the measurements for the plurality of satellites and previous measurements for the plurality of satellites. The one or more processors 210, possibly in combination with the one or more memories 220, in combination with the GNSS receiver 240, may comprise means for determining one or more corrected residuals based on one or more geometric relationships between the measurements for the plurality of satellites and one or more temporal relationships between the measurements for the plurality of satellites and previous measurements for the plurality of satellites.

For example, the one or more geometric relationships between the measurements for the plurality of satellites may include one or more geometric features between the plurality of satellites. In example implementations, the one or more geometric features may include a DOP contribution, a geometric redundancy for a given satellite, a gradient of LS solution, and/or a LS contribution.

For example, the one or more temporal relationships between the measurements for the plurality of satellites and previous measurements for the plurality of satellites may include one or more temporal features determined from GNSS measurements across position fixes and aggregating the features of the GNSS measurements over time. In an example implementation, one or more temporal encoders may process consecutive measurements from each satellite and aggregate the features over time, capturing temporal patterns in the measurements, such as level of noise in the measurements or temporal consistency. The temporal features may be used for measurement weighting in the generation of the corrected residuals.

At stage 1540, the method 1500 includes determining a position of the UE based on the one or more corrected residuals and the measurements for the plurality of satellites. The one or more processors 210, possibly in combination with the one or more memories 220, in combination with the GNSS receiver 240, may comprise means for determining a position of the UE based on the one or more corrected residuals and the measurements for the plurality of satellites.

### IMPLEMENTATION EXAMPLES

Clause 1. A user equipment, comprising: one or more memories; and one or more processors communicatively coupled to the one or more memories, the one or more processors being configured to: obtain measurements of signals transmitted by a plurality of satellites; determine one or more residuals based on the measurements for the plurality of satellites; determine one or more corrected residuals based on one or more relationships between the measurements for the plurality of satellites, or between the measurements for the plurality of satellites and previous measurements for the plurality of satellites; and determine a position of the user equipment based on the one or more corrected residuals and the measurements for the plurality of satellites.

Clause 2. The user equipment of clause 1, wherein the one or more relationships between the measurements for the plurality of satellites comprise: one or more geometric relationships between the measurements for the plurality of satellites based on one or more geometric features for the plurality of satellites.

Clause 3. The user equipment of clause 2, wherein the one or more geometric features comprise a dilution of precision (DOP) contribution for a given satellite of the plurality of satellites, comprising: a different between a first DOP for the current position fix that includes one or more measurements for the given satellite and a second DOP for the current position fix without the one or more measurements for the given satellite.

Clause 4. The user equipment of clause 2, wherein the one or more geometric features comprise a geometric redundancy for a given satellite of the plurality of satellites, comprising: a sum of alignments of angles between the given satellite and remaining satellites of the plurality of satellites.

Clause 5. The user equipment of clause 2, wherein the one or more geometric features comprise a gradient of least-squares (LS) solution, comprising: an amount a LS solution for a given satellite of the plurality of satellites changes based on a change in a residual of one or more measurements for the given satellite.

Clause 6. The user equipment of clause 2, wherein the one or more geometric features comprise a least-squares (LS) contribution, comprising: an amount one or more measurements for a given satellite of the plurality of satellites contributes to a LS solution for the given satellite.

Clause 7. The user equipment of clause 1, wherein the one or more relationships between the measurements for the plurality of satellites and the previous measurements for the plurality of satellites comprise: one or more temporal relationships between the measurements for the plurality of satellites and the previous measurements for the plurality of satellites based on one or more temporal features for the plurality of satellites.

Clause 8. The user equipment of clause 7, wherein the one or more temporal features comprise aggregated features of the measurements for the plurality of satellites and the previous measurements for the plurality of satellites.

Clause 9. The user equipment of clause 1, wherein the one or more processors configured to determine the one or more corrected residuals are further configured to: determine the one or more corrected residuals based on one or more geometric relationships between the measurements for the plurality of satellites and based and one or more temporal relationships between the measurements for the plurality of satellites and the previous measurements for the plurality of satellites.

Clause 10. The user equipment of clause 1, wherein the one or more processors configured to determine the position of the user equipment are further configured to: determine weighted measurements for each given satellite of the plurality of satellites based on the one or more relationships; and determine the one or more corrected residuals based on the weighted measurements.

Clause 11. A method for determining a position of a user equipment, comprising: obtaining measurements of signals transmitted by a plurality of satellites; determining one or more residuals based on the measurements for the plurality of satellites; determining one or more corrected residuals based on one or more relationships between the measurements for the plurality of satellites, or between the measurements for the plurality of satellites and previous measurements for the plurality of satellites for the plurality of satellites; and determining the position of the user equipment based on the one or more corrected residuals and the measurements for the plurality of satellites.

Clause 12. The method of clause 11, wherein the one or more relationships between the measurements for the plurality of satellites comprise: one or more geometric relationships between the measurements for the plurality of satellites based on one or more geometric features for the plurality of satellites.

Clause 13. The method of clause 12, wherein the one or more geometric features comprise a dilution of precision (DOP) contribution for a given satellite of the plurality of satellites, comprising: a different between a first DOP for the current position fix that includes one or more measurements for the given satellite and a second DOP for the current position fix without the one or more measurements for the given satellite.

Clause 14. The method of clause 12, wherein the one or more geometric features comprise a geometric redundancy for a given satellite of the plurality of satellites, comprising: a sum of alignments of angles between the given satellite and remaining satellites of the plurality of satellites.

Clause 15. The method of clause 12, wherein the one or more geometric features comprise a gradient of least-squares (LS) solution, comprising: an amount a LS solution for a given satellite of the plurality of satellites changes based on a change in a residual of one or more measurements for the given satellite.

Clause 16. The method of clause 12, wherein the one or more geometric features comprise a least-squares (LS) contribution, comprising: an amount one or more measurements for a given satellite of the plurality of satellites contributes to a LS solution for the given satellite.

Clause 17. The method of clause 11, wherein the one or more relationships between the measurements for the plurality of satellites and the previous measurements for the plurality of satellites comprise: one or more temporal relationships between the measurements for the plurality of satellites and the previous measurements for the plurality of satellites based on one or more temporal features for the plurality of satellites.

Clause 18. The method of clause 11, wherein the one or more temporal features comprise aggregated features of the measurements for the plurality of satellites and the previous measurements for the plurality of satellites.

Clause 19. The method of clause 11, wherein the determining of the one or more corrected residuals comprise: determining the one or more corrected residuals based on one or more geometric relationships between the measurements for the plurality of satellites and based and one or more temporal relationships between the measurements for the plurality of satellites and the previous measurements for the plurality of satellites.

Clause 20. The method of clause 11, wherein the determining of the position of the user equipment are further comprises: determining weighted measurements for each given satellite of the plurality of satellites based on the one or more relationships; and determining the one or more corrected residuals based on the weighted measurements.

Clause 21. A computing device, comprising: means for obtaining measurements of signals transmitted by a plurality of satellites; means for determining one or more residuals based on the measurements for the plurality of satellites; means for determining one or more corrected residuals based on one or more relationships between the measurements for the plurality of satellites in the current position fix, or between the measurements for the plurality of satellites in the current position fix and measurements for the plurality of satellites in one or more previous position fixes for the plurality of satellites; and means for determining a position of a user equipment based on the one or more corrected residuals and the measurements for the plurality of satellites.

Clause 22. The computing device of clause 21, wherein the one or more relationships between the measurements for the plurality of satellites comprise: one or more geometric relationships between the measurements for the plurality of satellites based on one or more geometric features for the plurality of satellites.

Clause 23. The computing device of clause 22, wherein the one or more geometric features comprise a dilution of precision (DOP) contribution for a given satellite of the plurality of satellites, comprising: a different between a first DOP for the current position fix that includes one or more measurements for the given satellite and a second DOP for the current position fix without the one or more measurements for the given satellite.

Clause 24. The computing device of clause 22, wherein the one or more geometric features comprise a geometric redundancy for a given satellite of the plurality of satellites, comprising: a sum of alignments of angles between the given satellite and remaining satellites of the plurality of satellites.

Clause 25. The computing device of clause 22, wherein the one or more geometric features comprise a gradient of least-squares (LS) solution, comprising: an amount a LS solution for a given satellite of the plurality of satellites changes based on a change in a residual of one or more measurements for the given satellite.

Clause 26. The computing device of clause 22, wherein the one or more geometric features comprise a least-squares (LS) contribution, comprising: an amount one or more measurements for a given satellite of the plurality of satellites contributes to a LS solution for the given satellite.

Clause 27. The computing device of clause 21, wherein the one or more relationships between the measurements for the plurality of satellites and the previous measurements for the plurality of satellites comprise: one or more temporal relationships between the measurements for the plurality of satellites and the previous measurements for the plurality of satellites based on one or more temporal features for the plurality of satellites.

Clause 28. The computing device of clause aim 21, wherein the one or more temporal features comprise aggregated features of the measurements for the plurality of satellites and the previous measurements for the plurality of satellites.

Clause 29. The computing device of clause 21, wherein the means for determining of the one or more corrected residuals comprise: means for determining the one or more corrected residuals based on one or more geometric relationships between the measurements for the plurality of satellites and based and one or more temporal relationships between the measurements for the plurality of satellites and the previous measurements for the plurality of satellites.

Clause 30. The computing device of clause 21, wherein the means for determining the position of the user equipment are further comprises: means for determining weighted measurements for each given satellite of the plurality of satellites based on the one or more relationships; and means for determining the one or more corrected residuals based on the weighted measurements.

Clause 31. A non-transitory, processor-readable storage medium comprising processor-readable instructions for determining a position of a user equipment, the processor-readable instructions to cause one or more processors to: obtain measurements of signals transmitted by a plurality of satellites; determine one or more residuals based on the measurements for the plurality of satellites; determine one or more corrected residuals based on one or more relationships between the measurements for the plurality of satellites in the current position fix, or between the measurements for the plurality of satellites in the current position fix and measurements for the plurality of satellites in one or more previous position fixes for the plurality of satellites; and determine the position of the user equipment based on the one or more corrected residuals and the measurements for the plurality of satellites.

Clause 32. The medium of clause 31, wherein the one or more relationships between the measurements for the plurality of satellites comprise: one or more geometric relationships between the measurements for the plurality of satellites based on one or more geometric features for the plurality of satellites.

Clause 33. The medium of clause 32, wherein the one or more geometric features comprise a dilution of precision (DOP) contribution for a given satellite of the plurality of satellites, comprising: a different between a first DOP for the current position fix that includes one or more measurements for the given satellite and a second DOP for the current position fix without the one or more measurements for the given satellite.

Clause 34. The medium of clause 32, wherein the one or more geometric features comprise a geometric redundancy for a given satellite of the plurality of satellites, comprising: a sum of alignments of angles between the given satellite and remaining satellites of the plurality of satellites.

Clause 35. The medium of clause 32, wherein the one or more geometric features comprise a gradient of least-squares (LS) solution, comprising: an amount a LS solution for a given satellite of the plurality of satellites changes based on a change in a residual of one or more measurements for the given satellite.

Clause 36. The medium of clause 32, wherein the one or more geometric features comprise a least-squares (LS) contribution, comprising: an amount one or more measurements for a given satellite of the plurality of satellites contributes to a LS solution for the given satellite.

Clause 37. The medium of clause 31, wherein the one or more relationships between the measurements for the plurality of satellites and the previous measurements for the plurality of satellites comprise: one or more temporal relationships between the measurements for the plurality of satellites and the previous measurements for the plurality of satellites based on one or more temporal features for the plurality of satellites.

Clause 38. The medium of clause 37, wherein the one or more temporal features comprise aggregated features of the measurements for the plurality of satellites and the previous measurements for the plurality of satellites.

Clause 39. The medium of clause 31, wherein the processor-readable instructions to cause the one or more processors to determine the one or more corrected residuals comprise processor-readable instructions to cause the one or more processors to: determine the one or more corrected residuals based on one or more geometric relationships between the measurements for the plurality of satellites and based and one or more temporal relationships between the measurements for the plurality of satellites and the previous measurements for the plurality of satellites.

Clause 40. The medium of clause 31, wherein the processor-readable instructions to cause the one or more processors to determine the position of the user equipment comprise processor-readable instructions to cause the one or more processors to: determine weighted measurements for each given satellite of the plurality of satellites based on the one or more relationships; and determine the one or more corrected residuals based on the weighted measurements.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes one or more of such devices (e.g., “a processor” includes one or more processors, “the processor” includes one or more processors, “a memory” includes one or more memories, “the memory” includes one or more memories, etc.). The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A user equipment, comprising:
one or more memories; and
one or more processors communicatively coupled to the one or more memories, the one or more processors being configured to:
obtain measurements of signals transmitted by a plurality of satellites;
determine one or more residuals based on the measurements for the plurality of satellites;
determine one or more corrected residuals based on one or more relationships between the measurements for the plurality of satellites, or between the measurements for the plurality of satellites and previous measurements for the plurality of satellites; and
determine a position of the user equipment based on the one or more corrected residuals and the measurements for the plurality of satellites.

2. The user equipment of claim 1, wherein the one or more relationships between the measurements for the plurality of satellites comprise: one or more geometric relationships between the measurements for the plurality of satellites based on one or more geometric features for the plurality of satellites.

3. The user equipment of claim 2, wherein the one or more geometric features comprise a dilution of precision (DOP) contribution for a given satellite of the plurality of satellites, comprising: a different between a first DOP for the current position fix that includes one or more measurements for the given satellite and a second DOP for the current position fix without the one or more measurements for the given satellite.

4. The user equipment of claim 2, wherein the one or more geometric features comprise a geometric redundancy for a given satellite of the plurality of satellites, comprising: a sum of alignments of angles between the given satellite and remaining satellites of the plurality of satellites.

5. The user equipment of claim 2, wherein the one or more geometric features comprise a gradient of least-squares (LS) solution, comprising: an amount a LS solution for a given satellite of the plurality of satellites changes based on a change in a residual of one or more measurements for the given satellite.

6. The user equipment of claim 2, wherein the one or more geometric features comprise a least-squares (LS) contribution, comprising: an amount one or more measurements for a given satellite of the plurality of satellites contributes to a LS solution for the given satellite.

7. The user equipment of claim 1, wherein the one or more relationships between the measurements for the plurality of satellites and the previous measurements for the plurality of satellites comprise: one or more temporal relationships between the measurements for the plurality of satellites and the previous measurements for the plurality of satellites based on one or more temporal features for the plurality of satellites.

8. The user equipment of claim 7, wherein the one or more temporal features comprise aggregated features of the measurements for the plurality of satellites and the previous measurements for the plurality of satellites.

9. The user equipment of claim 1, wherein the one or more processors configured to determine the one or more corrected residuals are further configured to: determine the one or more corrected residuals based on one or more geometric relationships between the measurements for the plurality of satellites and based and one or more temporal relationships between the measurements for the plurality of satellites and the previous measurements for the plurality of satellites.

10. The user equipment of claim 1, wherein the one or more processors configured to determine the position of the user equipment are further configured to: determine weighted measurements for each given satellite of the plurality of satellites based on the one or more relationships; and determine the one or more corrected residuals based on the weighted measurements.

11. A method for determining a position of a user equipment, comprising:
obtaining measurements of signals transmitted by a plurality of satellites;
determining one or more residuals based on the measurements for the plurality of satellites;
determining one or more corrected residuals based on one or more relationships between the measurements for the plurality of satellites, or between the measurements for the plurality of satellites and previous measurements for the plurality of satellites for the plurality of satellites; and
determining the position of the user equipment based on the one or more corrected residuals and the measurements for the plurality of satellites.

12. The method of claim 11, wherein the one or more relationships between the measurements for the plurality of satellites comprise: one or more geometric relationships between the measurements for the plurality of satellites based on one or more geometric features for the plurality of satellites.

13. The method of claim 12, wherein the one or more geometric features comprise a dilution of precision (DOP) contribution for a given satellite of the plurality of satellites, comprising: a different between a first DOP for the current position fix that includes one or more measurements for the given satellite and a second DOP for the current position fix without the one or more measurements for the given satellite.

14. The method of claim 12, wherein the one or more geometric features comprise a geometric redundancy for a given satellite of the plurality of satellites, comprising: a sum of alignments of angles between the given satellite and remaining satellites of the plurality of satellites.

15. The method of claim 12, wherein the one or more geometric features comprise a gradient of least-squares (LS) solution, comprising: an amount a LS solution for a given satellite of the plurality of satellites changes based on a change in a residual of one or more measurements for the given satellite.

16. The method of claim 12, wherein the one or more geometric features comprise a least-squares (LS) contribution, comprising: an amount one or more measurements for a given satellite of the plurality of satellites contributes to a LS solution for the given satellite.

17. The method of claim 11, wherein the one or more relationships between the measurements for the plurality of satellites and the previous measurements for the plurality of satellites comprise: one or more temporal relationships between the measurements for the plurality of satellites and the previous measurements for the plurality of satellites based on one or more temporal features for the plurality of satellites.

18. The method of claim 11, wherein the one or more temporal features comprise aggregated features of the measurements for the plurality of satellites and the previous measurements for the plurality of satellites.

19. The method of claim 11, wherein the determining of the one or more corrected residuals comprise: determining the one or more corrected residuals based on one or more geometric relationships between the measurements for the plurality of satellites and based and one or more temporal relationships between the measurements for the plurality of satellites and the previous measurements for the plurality of satellites.

20. A computing device, comprising:
means for obtaining measurements of signals transmitted by a plurality of satellites;
means for determining one or more residuals based on the measurements for the plurality of satellites;
means for determining one or more corrected residuals based on one or more relationships between the measurements for the plurality of satellites in the current position fix, or between the measurements for the plurality of satellites in the current position fix and measurements for the plurality of satellites in one or more previous position fixes for the plurality of satellites; and
means for determining a position of a user equipment based on the one or more corrected residuals and the measurements for the plurality of satellites.
